(19) United States
(12) Patent Application Publication
(10) Pub. No.: US 2024/0256933 A1
(43) Pub. Date: Aug. 1, 2024

(54) METHODS AND SYSTEMS FOR EIGENSTATE PREPARATION OF A TARGET HAMILTONIAN ON A QUANTUM COMPUTER

(71) Applicant: 1QB Information Technologies Inc., Vancouver (CA)

(72) Inventors: Jessica LEMIEUX, San Francisco, CA (US); Artur SCHERER, Cochrane (CA); Pooya RONAGH, Guelph (CA)

(21) Appl. No.: 18/614,468

(22) Filed: Mar. 22, 2024

Related U.S. Application Data
(63) Continuation of application No. PCT/IB2022/059253, filed on Sep. 28, 2022.
(60) Provisional application No. 63/249,804, filed on Sep. 29, 2021.

(51) Int. Cl. G06N 10/20

(52) U.S. Cl. CPC G06N 10/20

(57) ABSTRACT

A method and a system for preparing an eigenstate of a target Hamiltonian using a non-classical computer are disclosed. The method may include: obtaining a reflection path between an initial Hamiltonian and a target Hamiltonian; using one or more target eigenstates to obtain a sequence of reflections along the reflection path; and using the non-classical computer to perform the sequence of reflections along said reflection path. The system may consist of a quantum computer, a digital computer and a communications interface for providing instructions to the quantum computer and for obtaining quantum measurements results from the quantum computer.

### CROSS-REFERENCE

This application is a continuation of International Application No. PCT/IB2022/059253, filed on Sep. 28, 2022, which claims the benefit of U.S. Provisional Application No. 63/249,804, filed on Sep. 29, 2021, each of which is incorporated by reference herein for all purposes.

### BACKGROUND

Quantum computers typically make use of quantum-mechanical phenomena, such as superposition and entanglement, to perform operations on a quantum system representative of data. The Hamiltonian of a quantum system is an operator corresponding to the total energy of that system. The Hamiltonian has eigenstates corresponding to total energy levels. It may be advantageous to accurately and efficiently prepare an eigenstate in order to find a solution to a problem to be solved using a quantum computer. However, eigenstate preparation of both classical and quantum Hamiltonians may be useful in various fields, including applications such as, for example, solving NP-hard optimization problems with classical or non-classical objective functions as well as electronic structure quantum simulations of molecules in chemistry and materials science.

### SUMMARY

The present disclosure provides methods and systems for eigenstate preparation of a target Hamiltonian on a quantum computer. The present disclosure may improve upon existing methods for eigenstate preparation in at least some aspects by using a quantum device advantageously.

Systems and methods of the present disclosure provide at least some of the following advantages. In some cases, an advantage of the methods and systems disclosed herein may be that they may be used in circuit-based quantum computing and may use quantum error correction which may allow for better scalability. In some cases, another advantage of the methods and systems disclosed herein may be that they may avoid intermediate projective measurements for which the error and time may be greater than it is for quantum gates. In some cases, another advantage of the methods and systems disclosed herein may be that they may impose fewer restrictions on the problem type. For example, they may relieve a need to ensure non-degeneracy or a detailed-balance condition. In some cases, another advantage of the methods and systems disclosed herein may be that significant overlap between the starting state of the system and the target state to be prepared may not be required. For example, the overlap may merely be non-zero. In some cases, another advantage of the methods and systems disclosed herein may be that the settings may be flexible such that multiple tools may be integrated in a similar context, such as, for example, qubitization. The methods and systems disclosed herein may allow for easy and performant heuristic implementations of the algorithms. In some cases, another advantage of the methods and systems disclosed herein may be that reflections may be deterministic, as opposed to projective measurements used in some of the existing methods. In some cases, another advantage of the methods and systems disclosed herein may be that they may take advantage of a structure of the problem. In some cases, another advantage of the methods and systems disclosed herein may be that as the number of reflections is increased, the probability of success increases. For example, the probability of success may not be periodic, in contrast to, for example, Grover's algorithm. The average number of reflections needed to solve NP-hard problems may decrease compared to existing methods.

In an aspect, the present disclosure provides a method for preparing an eigenstate of a target Hamiltonian using a non-classical computer. The method may comprise: (a) obtaining a reflection path between an initial Hamiltonian and a target Hamiltonian; (b) using one or more target eigenstates to obtain a sequence of reflections along said reflection path; and (c) using a non-classical computer to perform said sequence of reflections along said reflection path.

In some embodiments, said non-classical computer is a quantum computer. In some embodiments, prior to (a), the method comprises preparing an eigenstate of said initial Hamiltonian on said quantum computer, which eigenstate is not orthogonal to said one or more target eigenstates. In some embodiments, subsequent to (c), the method comprises, at said quantum computer, performing a measurement in the eigenbasis of said target Hamiltonian, and, optionally, wherein said measurement in said eigenbasis of said target Hamiltonian is performed to check that said one or more target eigenstates are achieved. In some embodiments, said measurement is a quantum measurement. In some embodiments, the method further comprises obtaining an indication of a superposition of said one or more target eigenstates. In some embodiments, said indication of said one or more target eigenstates comprises at least one of: energy intervals, an integer number representative of a number of eigenstates having the lowest energies, an integer number representative of a number of eigenstates having the highest energies, labels, and a binary function that marks the target eigenstates.

In some embodiments, (c) comprises, at said quantum computer, performing said sequence of reflections using a plurality of gate operations. In some embodiments, said plurality of gate operations comprises phase kickback. In some embodiments, said plurality of gate operations comprises energy comparison. In some embodiments, (c) comprises, at said quantum computer, performing a quantum phase estimation without performing an energy measurement. In some embodiments, (c) comprises, at said quantum computer, performing at least one of qubitization, quantum signal processing, and partial energy measurement. In some embodiments, said quantum measurement comprises performing at least one of qubitization, quantum signal processing, and partial energy measurement.

In some embodiments, said quantum computer comprises at least one member of the group consisting of: a circuit-based quantum computer, a superconducting quantum computer, a trapped ion quantum computer, a quantum dot computer, an optical quantum computer, a nuclear magnetic resonance (NMR) quantum computers, a solid-state NMR Kane quantum computer, an electrons-on-helium quantum computer, a cavity quantum electrodynamics-based quantum computer, a molecular magnet-based quantum computer, a fullerene-based ESR quantum computer, a diamond-based quantum computer, a Bose-Einstein condensate-based quantum computer, a transistor-based quantum computer; a rare-earth-metal-ion-doped inorganic crystal-based quantum computer, and a metal-like carbon nanospheres based quantum computer.

In some embodiments, (a)-(c) are repeated at least once. In some embodiments, (a)-(c) and said preparing said eigenstate of said initial Hamiltonian on said quantum computer are repeated at least once. In some embodiments, (a)-(c) and said performing said measurement in the eigenbasis of said target Hamiltonian are repeated at least once. In some embodiments, (a)-(c) and said providing indication of superposition of said one or more target eigenstates are repeated at least once. In some embodiments, (a) comprises receiving said reflection path from a user. In some embodiments, (b) comprises receiving said sequence of reflections from a user. In some embodiments, (b) comprises using an optimization protocol to obtain said sequence of reflections, wherein said optimization protocol comprises at least one member of the group consisting of: a gradient-based optimization procedure and a derivative free optimization procedure.

In some embodiments, (b) comprises using an optimization protocol to obtain said sequence of reflections, wherein said optimization protocol is based at least in part on at least one method selected from the group consisting of a gradient descent, a stochastic gradient descent, a steepest descent, a Bayesian optimization, a random search, and a local search. In some embodiments, (b) comprises using machine learning method to obtain said sequence of reflections. In some embodiments, (a) or (b) or both comprise using prior information to obtain said sequence of reflections, said reflection path, or both. In some embodiments, (a) comprises using an adiabatic path to obtain said reflection path. In some embodiments, said target Hamiltonian is representative of at least one member of the group consisting of: an optimization problem, a kSAT problem, a spin-glass problem, and a quadratic unconstraint binary optimization problem.

In some embodiments, said target Hamiltonian is representative of at least one of a quantum many-body system, a fermionic system, and a bosonic system. In some embodiments, said target Hamiltonian is representative of an optimization problem with at least one constraint. In some embodiments, said eigenstate of said initial Hamiltonian is the ground state of said initial Hamiltonian, and wherein said ground state defines a region representative of said at least one constraint of said optimization problem. In some embodiments, said preparing an eigenstate of said initial Hamiltonian on a non-classical computer comprises constructing said eigenstate from a unitary decomposition. In some embodiments, (c) comprises using a classical computing system operatively connected to said non-classical computer to direct to said non-classical computer one or more instructions, said one or more instructions configured to perform said sequence of reflections along said reflection path. In some embodiments, prior to (a), the method comprises obtaining an indication of said target Hamiltonian and an indication of said one or more target eigenstates. In some embodiments, prior to (a), the method comprises obtaining an indication of said initial Hamiltonian. In some embodiments, said indication of said initial Hamiltonian comprises a domain of an optimization problem.

In another aspect, the present disclosure provides a system for eigenstate preparation of a target Hamiltonian on a quantum computer. The system comprises: a communications interface for providing instructions to said quantum computer, and for obtaining quantum measurements results; and a digital computer comprising an interface and a non-transitory computer readable medium operatively coupled to a processor, said non-transitory computer readable medium comprising instructions, wherein said processor is configured to execute said instructions to at least: (a) obtain a reflection path between an initial Hamiltonian and a target Hamiltonian; (b) use one or more eigenstates to obtain a sequence of reflections along said reflection path; and (c) provide instructions, using said communications interface, to said quantum computer to perform a sequence of reflections along said reflection path.

In some embodiments, said non-classical computer is a quantum computer. In some embodiments, said processor is configured to execute said instructions to prepare an eigenstate of said initial Hamiltonian on said quantum computer, which eigenstate is not orthogonal to said one or more target eigenstates. In some embodiments, said quantum computer is configured to perform a measurement in the eigenbasis of said target Hamiltonian, and, optionally, wherein said measurement in said eigenbasis of said target Hamiltonian is performed to check that said one or more target eigenstates are achieved. In some embodiments, said measurement is a quantum measurement. In some embodiments, said processor is configured to execute said instructions to obtain an indication of a superposition of said one or more target eigenstates. In some embodiments, said indication of said one or more target eigenstates comprises at least one of: energy intervals, an integer number representative of a number of eigenstates having the lowest energies, an integer number representative of a number of eigenstates having the highest energies, labels, and a binary function that marks the target eigenstates.

In some embodiments, said quantum computer is configured to perform said sequence of reflections using a plurality of gate operations. In some embodiments, said plurality of gate operations comprises phase kickback. In some embodiments, said plurality of gate operations comprises an energy comparison. In some embodiments, (c) comprises instruction to direct said quantum computer to perform a quantum phase estimation without performing an energy measurement. In some embodiments, (c) comprises instruction to direct said quantum computer to perform at least one of qubitization, quantum signal processing, and partial energy measurement. In some embodiments, said quantum measurement comprises performing at least one of qubitization, quantum signal processing, and partial energy measurement.

In some embodiments, said quantum computer comprises at least one member of the group consisting of: a circuit-based quantum computer, a superconducting quantum computer, a trapped ion quantum computer, a quantum dot computer, an optical quantum computer, a nuclear magnetic resonance (NMR) quantum computers, a solid-state NMR Kane quantum computer, an electrons-on-helium quantum computer, a cavity quantum electrodynamics-based quantum computer, a molecular magnet-based quantum computer, a fullerene-based ESR quantum computer, a diamond-based quantum computer, a Bose-Einstein condensate-based quantum computer, a transistor-based quantum computer; a rare-earth-metal-ion-doped inorganic crystal-based quantum computer, and a metal-like carbon nanospheres based quantum computer.

In some embodiments, said processor is further configured to repeat said instructions to (a)-(c) at least once. In some embodiments, said processor is further configured to repeat said instructions to (a)-(c) and to prepare said eigenstate of said initial Hamiltonian on said quantum computer at least once. In some embodiments, said processor is further configured to repeat said instructions to (a)-(c) and to perform said measurement in the eigenbasis of said target

Hamiltonian at least once. In some embodiments, said processor is further configured to repeat said instructions to (a)-(c) and to provide an indication of superposition of said one or more target eigenstates at least once. In some embodiments, said processor is further configured to receive said reflection path from a user. In some embodiments, said processor is further configured to receive said sequence of reflections from a user. In some embodiments, said processor is further configured to use an optimization protocol to obtain said sequence of reflections, wherein said optimization protocol comprises at least one member of the group consisting of: a gradient-based optimization procedure, a derivative free optimization procedure.

In some embodiments, said processor is further configured to use an optimization protocol to obtain said sequence of reflections, wherein said optimization protocol is based at least in part on at least one method selected from the group consisting of a gradient descent, a stochastic gradient descent, a steepest descent, a Bayesian optimization, a random search, and a local search. In some embodiments, said processor is further configured to use a machine learning method to obtain said sequence of reflections. In some embodiments, at least one of said sequence of reflections and said reflection path is obtained using prior information. In some embodiments, said reflection path is obtained using an adiabatic path. In some embodiments, said target Hamiltonian is representative of at least one member of the group consisting of: an optimization problem, a kSAT problem, a spin-glass problem, and a quadratic unconstraint binary optimization problem. In some embodiments, target Hamiltonian is representative of at least one of a quantum many-body system, a fermionic system, and a bosonic system.

In some embodiments, said target Hamiltonian is representative of an optimization problem with at least one constraint. In some embodiments, said eigenstate of said initial Hamiltonian is the ground state of said initial Hamiltonian, and wherein said ground state defines a region representative of said at least one constraint of said optimization problem. In some embodiments, said processor is further configured to construct said eigenstate from a unitary decomposition. In some embodiments, prior to (a), said processor is further configured to obtain an indication of said target Hamiltonian and an indication of said one or more target eigenstates. In some embodiments, prior to (a), said processor is further configured to obtain an indication of said initial Hamiltonian. In some embodiments, said indication of said initial Hamiltonian comprises a domain of an optimization problem.

In another aspect, the present disclosure provides a method for preparing an eigenstate of a target Hamiltonian using a non-classical computer. The method may comprise (a) obtaining an indication of a target Hamiltonian and an indication of one or more target eigenstates; (b) obtaining an indication of an initial Hamiltonian; (c) obtaining a reflection path between the initial Hamiltonian and the target Hamiltonian; (d) using the indication of the one or more target eigenstates to obtain a sequence of reflections along the reflection path; and (e) using a non-classical computer to perform the sequence of reflections along the reflection path.

In some embodiments, a non-classical computer is a quantum computer. In some embodiments, prior to (c), the method comprises preparing an eigenstate of the initial Hamiltonian on the quantum computer, which eigenstate is not orthogonal to the one or more target eigenstates. In some embodiments, subsequent to (e), the method comprises performing a measurement in the eigenbasis of the target Hamiltonian to check that the one or more target eigenstates are achieved. In some embodiments, the measurement is a quantum measurement. In some embodiments, the method further comprises providing indication of superposition of the one or more target eigenstates. In some embodiments, the indication of the one or more target eigenstates comprises at least one of: energy intervals, an integer number representative of a number of eigenstates having the lowest energies, an integer number representative of a number of eigenstates having the highest energies, labels, and a binary function that marks the target eigenstates. In some embodiments, the sequence of reflections is performed using gate operations. In some embodiments, the gate operations comprises phase kickback. In some embodiments, the gate operations comprise energy comparison. In some embodiments, the performing the sequence of reflections comprises quantum phase estimation without performing the energy measurement. In some embodiments, the performing the sequence of reflections comprises at least one of qubitization, quantum signal processing, and partial energy measurement. In some embodiments, the performing the quantum measurement comprises at least one of qubitization, quantum signal processing, and partial energy measurement. In some embodiments, the quantum computer comprises at least one member of the group consisting of: a circuit-based quantum computer, a superconducting quantum computer, a trapped ion quantum computer, a quantum dot computer, an optical quantum computers, nuclear magnetic resonance quantum computers, solid-state NMR Kane quantum computers, electrons-on-helium quantum computers, cavity quantum electrodynamics-based quantum computers, molecular magnet-based quantum computers, fullerene-based ESR quantum computers, diamond-based quantum computers, Bose-Einstein condensate-based quantum computers, transistor-based quantum computers; rare-earth-metal-ion-doped inorganic crystal-based quantum computers, and metal-like carbon nanospheres based quantum computers.

In some embodiments, (c)-(e) are repeated a number of times. In some embodiments, (c)-(e) and the preparing an eigenstate of the initial Hamiltonian on the quantum computer are repeated a number of times. In some embodiments, (c)-(e) and the performing a measurement in the eigenbasis of the target Hamiltonian to check that the one or more target eigenstates are achieved are repeated a number of times. In some embodiments, (c)-(e) and the providing indication of superposition of the one or more target eigenstates are repeated a number of times. In some embodiments, the reflection path is obtained from a user. In some embodiments, the sequence of reflections is obtained from a user. In some embodiments, the sequence of reflections is obtained using an optimization protocol comprising at least one member of the group consisting of: a gradient-based optimization procedure, a derivative free optimization procedure. In some embodiments, the sequence of reflections is obtained using an optimization protocol based on at least one method selected from the group consisting of a gradient descent, a stochastic gradient descent, a steepest descent, a Bayesian optimization, a random search, and a local search. In some embodiments, the sequence of reflections is obtained using machine learning method.

In some embodiments, at least one of the sequence of reflections and the reflection path is obtained using prior information. In some embodiments, the reflection path is obtained using adiabatic path. In some embodiments, the target Hamiltonian is representative of at least one member of the group consisting of: an optimization problem, a kSAT problem, a spin-glass problem, and a quadratic unconstraint binary optimization problem. In some embodiments, the target Hamiltonian is representative of at least one of a quantum many-body system, a fermionic system, and a bosonic system. In some embodiments, the target Hamiltonian is representative of an optimization problem with at least one constraint. In some embodiments, the eigenstate of the initial Hamiltonian is the ground state of the initial Hamiltonian, further wherein the ground state defines a region representative of the at least one constraint of the optimization problem. In some embodiments, the preparing an eigenstate of the initial Hamiltonian on a quantum computer comprises construction from a unitary decomposition. In some embodiments, (e) comprises using a classical computing system operatively connected to the non-classical computer to direct the non-classical computer instructions to perform the sequence of reflections along the reflection path. In some embodiments, the indication of the initial Hamiltonian comprises a domain of an optimization problem.

In another aspect, the present disclosure provides a system for eigenstate preparation of a target Hamiltonian on a quantum computer. The system may comprise: (a) a communications interface for providing instructions to the quantum computer, and for obtaining quantum measurements results; and (b) a digital computer comprising an interface and a non-transitory computer readable medium operatively coupled to a processor, the non-transitory computer readable medium comprising instructions, wherein the processor is configured to execute the instructions to at least: obtain an indication of a target Hamiltonian and an indication of one or more target eigenstates, obtain an indication of an initial Hamiltonian; obtain a reflection path between the initial Hamiltonian and the target Hamiltonian; obtain a sequence of reflections along the reflection path; using the communications interface provide instructions to the quantum computer to perform a sequence of reflections, and perform a quantum measurement in the eigenbasis of the target Hamiltonian; and obtain superposition of the one or more target eigenvalues from the quantum computer using the communications interface.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in the art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 is a diagram of a system for eigenstate preparation of a target Hamiltonian on a quantum computer.

FIG. 2 is a flowchart of a method for eigenstate preparation of a target Hamiltonian on a quantum computer.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than,” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Certain inventive embodiments herein contemplate numerical ranges. When ranges are present, the ranges include the range endpoints. Additionally, every sub-range and value within the range is present as if explicitly written out.

The term “about” or “approximately” may mean within an acceptable error range for the particular value, which will depend in part on how the value is measured or determined, e.g., the limitations of the measurement system. For example, “about” may mean within 1 or more than 1 standard deviation, per the practice in the art. Alternatively, “about” may mean a range of up to 20%, up to 10%, up to 5%, or up to 1% of a given value. Where particular values are described in the application and claims, unless otherwise stated the term “about” meaning within an acceptable error range for the particular value may be assumed.

As used herein, the term “classical,” as used in the context of computing or computation, generally refers to computation performed using binary values using discrete bits without use of quantum mechanical superposition and quantum mechanical entanglement. A classical computer may be a digital computer, such as a computer employing discrete bits (e.g., 0's and 1's) without use of quantum mechanical superposition and quantum mechanical entanglement.

As used herein, the term “non-classical,” as used in the context of computing or computation, generally refers to any method or system for performing computational procedures outside of the paradigm of classical computing.

As used herein, the term “quantum device” generally refers to any device or system for performing computations using any quantum mechanical phenomenon such as quantum mechanical superposition and quantum mechanical entanglement.

As used herein, the terms “quantum computation,” “quantum procedure,” “quantum operation,” and “quantum computer” generally refer to any method or system for performing computations using quantum mechanical operations (such as unitary transformations or completely positive trace-preserving (CPTP) maps on quantum channels) on a Hilbert space represented by a quantum device.

As used herein, the term “qubit” generally refers to a unit of quantum information processing whose quantum state is a complex unit vector of dimension 2. These two dimensions are typically referred to as “0” and “1”. When quantum error correction is used, a logical qubit refers to a set of physical qubits that encodes one fault-tolerant qubit.

As used herein, the term “data qubit” generally refers to one of the qubits used to encode quantum information for a quantum computation. It may contain a part of an input or a part of an output state. If quantum error correction is used, it refers to a logical qubit, and if not, it refers to a physical qubit.

As used herein, the term “register” generally refers to a set of qubits used to perform a quantum computation. Different registers may refer to different parts of the computation.

As used herein, the term “quantum gate” generally refers to a manipulation of qubits that can be represented by unitary operation on the quantum state of the qubits.

As used herein, the term “quantum gate operation” generally refers to a quantum gate, a sequence of quantum gates, or a combination of quantum gates and quantum measurements that perform an isometry on the quantum state of qubits.

As used herein, the term “ancilla qubit” generally refers to one of the additional qubits, used to perform a quantum gate operation more efficiently or to perform intermediate computations. If quantum error correction is used, it refers to a logical qubit, and if not, it refers to a physical qubit.

As used herein, the term “optimization problem” generally refers to any problem involving minimizing or maximizing an objective function defined on a given domain.

As used herein, the term “optimization protocol” generally refers to a protocol, an algorithm, or a method for solving an optimization problem exactly or approximately.

Eigenstate preparation of both classical and quantum Hamiltonians may be important in various fields. It may be used to solve a problem in statistical zero knowledge complexity class (see, for example, Aharonov et al., “Adiabatic quantum state generation and statistical zero knowledge,” STOC '03: Proceedings of the thirty-fifth annual ACM symposium on Theory of computing, pp. 20-29, 2003, which is incorporated by reference herein for all purposes). It may be used in approximate computing (see, for example, Han et al., “Approximate computing: An emerging paradigm for energy-efficient design,” 2013 18th IEEE European Test Symposium (ETS), IEEE, 2013, which is incorporated by reference herein for all purposes). Eigenstate preparation may be used as a subroutine for solving, for example, quantum linear systems (see, for example, An et al., “Quantum linear system solver based on time-optimal adiabatic quantum computing and quantum approximate optimization algorithm,” arXiv: 1909.05500, 2019, which is incorporated by reference herein for all purposes). Eigenstate preparation may be used as part or in replacement of quantum search (see, for example, Grover, “A fast quantum mechanical algorithm for database search,” in Proceedings of the twenty-eighth annual ACM symposium on Theory of computing, pp. 212-219, 1996; and Brassard et al., “An exact quantum polynomial-time algorithm for Simon's problem,” in Proceedings of the Fifth Israeli Symposium on Theory of Computing and Systems, IEEE, 1997; each of which is incorporated by reference herein for all purposes). It may be used as a pre-processing of the algorithm, to create or reduce the database, for example, or to directly find the solution. It may be used for quantum Metropolis sampling (see, for example, Temme et al., “Quantum Metropolis sampling,” Nature 471, pp. 87-90, 2011, which is incorporated by reference herein for all purposes), where the algorithm permits sampling directly from the eigenstates of the Hamiltonian. It may also be used to solve NP-hard problems (see, for example, Kaminsky et al., “Scalable architecture for adiabatic quantum computing of NP-hard problems,” Quantum computing and quantum bits in mesoscopic systems, pp. 229-236, 2004, which is incorporated by reference herein for all purposes). Quantum simulation may use eigenstate preparation to initialize quantum computers in a quantum many-body eigenstate (see, for example, Whitfield et al., “Simulation of electronic structure Hamiltonians using quantum computers,” Molecular Physics 109:5, pp. 735-750, 2011, which is incorporated by reference herein for all purposes).

There exist various algorithms and heuristics for eigenstate preparation, for example: Grover's algorithm (for quantum search; see, for example, Grover, “A fast quantum mechanical algorithm for database search,” in Proceedings of the twenty-eighth annual ACM symposium on Theory of computing, pp. 212-219, 1996, which is incorporated by reference herein for all purposes); adiabatic state preparation, where an eigenstate of an instantaneous Hamiltonian of a time-dependent Hamiltonian is prepared by an adiabatic evolution (for continuous quantum computing; see, for example, Farhi et al., “Quantum computation by adiabatic evolution,” arXiv:quant-ph/0001106, 2000, which is incorporated by reference herein for all purposes); discrete adiabatic state preparation, where, instead of an evolution, projective measurements from a discretization of an adiabatic path may be used (see, for example, Lemieux et al., “Resource estimate for quantum many-body ground-state preparation on a quantum computer,” Physical Review A 103, no. 5:052408, 2021, which is incorporated by reference herein for all purposes); eigenpath traversal by phase randomization instead of projective measurements (see, for example, Boixo et al., “Quantum state preparation by phase randomization,” arXiv:0903.1652, 2009, which is incorporated by reference herein for all purposes) or by alternating reflections or Grover iterations, and projections (see, for example, Boixo et al., “Fast quantum algorithms for traversing paths of eigenstates,” arXiv: 1005.3034, 2010, which is incorporated by reference herein for all purposes); the quantum approximate optimization algorithm, where unitary operators defined by a sequence of angles and also projective measurements are used (see, for example, Farhi et al., “A quantum approximate optimization algorithm,” arXiv:1411.4028, 2014, which is incorporated by reference herein for all purposes); and quantum walks, where a steady state from a sequence of reflections defined by a reversible Markov chain is prepared (see, for example, Lemieux et al., “Efficient Quantum Walk Circuits for Metropolis-Hastings Algorithm,” Quantum 4, p. 287, 2020, which is incorporated by reference herein for all purposes).

However, the above-mentioned methods may have at least some drawbacks. The probability of success of Grover's algorithm may be periodic, for example, increasing the number of iterations may decrease the probability of success. In continuous quantum computing, quantum error correction may not be useful for better scalability. Projective measurements may cause the wave function to collapse into an undesired subspace at any intermediate steps of the above-mentioned methods.

Optimization of the variational parameters may yield exponential decay of the barren plateau which would require an exponential growth of the resources for the desired level of precision. Traversing paths of eigenstates may require a great degree of overlap between states. Problems solved by the quantum Metropolis-Hastings algorithm may require compliance with a detailed-balance condition.

Recognized herein is the need for improved methods and systems that may overcome at least one of the above-identified drawbacks.

### Quantum Device

Any type of quantum computer may be suitable for the technologies disclosed herein. A quantum processor or quantum computer may comprise one or more adiabatic quantum computers, quantum gate arrays, one-way quantum computers, topological quantum computers, quantum Turing machines, superconductor-based quantum computers, trapped ion quantum computers, trapped atom quantum computers, optical lattices, quantum dot computers, spin-based quantum computers, spatial-based quantum computers, Loss-Di Vincenzo quantum computers, nuclear magnetic resonance (NMR) based quantum computers, solution-state NMR quantum computers, solid-state NMR quantum computers, solid-state NMR Kane quantum computers, electrons-on-helium quantum computers, cavity-quantum-electrodynamics based quantum computers, molecular magnet quantum computers, fullerene-based quantum computers, linear optical quantum computers, diamond-based quantum computers, nitrogen-vacancy (NV) diamond-based quantum computers, Bose-Einstein condensate-based quantum computers, transistor-based quantum computers, and rare-earth-metal-ion-doped inorganic crystal based quantum computers. The quantum processor or quantum computer may comprise one or more of: quantum annealers, Ising solvers, optical parametric oscillators (OPO), and gate model quantum computers.

A quantum processor or quantum computer may comprise one or more qubits. The one or more qubits may comprise superconducting qubits, trapped ion qubits, trapped atom qubits, photon qubits, quantum dot qubits, electron spin-based qubits, nuclear spin-based qubits, molecular magnet qubits, fullerene-based qubits, diamond-based qubits, nitrogen-vacancy (NV) diamond-based qubits, Bose-Einstein condensate-based qubits, transistor-based qubits, or rare-earth-metal-ion-doped inorganic crystal based qubits.

In accordance with the description herein, suitable quantum computers may include, by way of non-limiting examples including the associated references, each of which are incorporated by reference in their entireties: superconducting quantum computers (qubits implemented as small superconducting circuits—Josephson junctions) (Clarke et al., “Superconducting quantum bits,” Nature 453, no. 7198, pp. 1031-1042, 2008); trapped-ion quantum computers (qubits implemented as states of trapped ions) (Kielpinski et al., “Architecture for a large-scale ion-trap quantum computer,” Nature 417, no. 6890, pp 709-711, 2002); optical lattice quantum computers (qubits implemented as states of neutral atoms trapped in an optical lattice) (Deutsch et al., “Quantum computing with neutral atoms in an optical lattice,” Fortschritte der Physik: Progress of Physics 48, no. 9-11, pp. 925-943, 2000); spin-based quantum dot computers (qubits implemented as the spin states of trapped electrons) (Imamoglu et al., “Quantum information processing using quantum dot spins and cavity QED,” Physical Review Letters 83, no. 20, p. 4204, 1999); spatial-based quantum dot computers (qubits implemented as electron positions in a double quantum dot) (Fedichkin et al., “Novel coherent quantum bit using spatial quantization levels in semiconductor quantum dot,” arXiv:quant-ph/0006097, 2000); coupled quantum wires (qubits implemented as pairs of quantum wires coupled by quantum point contact) (Bertoni et al., “Quantum logic gates based on coherent electron transport in quantum wires,” Physical Review Letters 84, no. 25, p. 5912, 2000); nuclear magnetic resonance quantum computers (qubits implemented as nuclear spins and probed by radio waves) (Cory et al., “Nuclear magnetic resonance spectroscopy: An experimentally accessible paradigm for quantum computing,” arXiv:quant-ph/9709001, 1997); solid-state NMR Kane quantum computers (qubits implemented as the nuclear spin states of phosphorus donors in silicon) (Kane, “A silicon-based nuclear spin quantum computer,” Nature 393, no. 6681, pp. 133-137, 1998); electrons-on-helium quantum computers (qubits implemented as electron spins) (Lyon, “Spin-based quantum computing using electrons on liquid helium,” arXiv:cond-mat/0301581, 2006); cavity quantum electrodynamics-based quantum computers (qubits implemented as states of trapped atoms coupled to high-finesse cavities) (Burell, “An Introduction to Quantum Computing using Cavity QED concepts,” arXiv: 1210.6512, 2012); molecular magnet-based quantum computers (qubits implemented as spin states) (Leuenberger et al., “Quantum Computing in Molecular Magnets,” arXiv:cond-mat/0011415, 2001); fullerene-based electron spin resonance (ESR) quantum computers (qubits implemented as electronic spins of atoms or molecules encased in fullerenes) (Harneit, “Spin Quantum Computing with Endohedral Fullerenes,” arXiv:1708.09298, 2017); linear optical quantum computers (qubits implemented as processing states of different modes of light through linear optical elements such as mirrors, beam splitters and phase shifters) (Knill et al. “Efficient linear optics quantum computation,” arXiv:quant-ph/0006088, 2000); diamond-based quantum computers (qubits implemented as electronic or nuclear spins of nitrogen-vacancy (NV) centres in diamond) (Nizovtsev et al., “A quantum computer based on NV centers in diamond: optically detected nutations of single electron and nuclear spins,” Optics and spectroscopy 99, no. 2, pp. 233-244, 2005); Bose-Einstein condensate-based quantum computers (qubits implemented as two-component Bose-Einstein condensates) (Byrnes et al., “Macroscopic quantum computation using Bose-Einstein condensates,” arXiv:quantum-ph/1103.5512, 2011); transistor-based quantum computers (qubits implemented as semiconductors coupled to nanophotonic cavities) (Sun et al., “A single-photon switch and transistor enabled by a solid-state quantum memory,” arXiv:quant-ph/1805.01964, 2018); rare-earth-metal-ion-doped inorganic crystal-based quantum computers (qubits implemented as atomic ground state hyperfine levels in rare-earth-ion-doped inorganic crystals) (Ohlsson et al. “Quantum computer hardware based on rare-earth-ion-doped inorganic crystals,” Optics Communications 201, no. 1-3, pp. 71-77, 2002); and metal-like carbon nanospheres based quantum computers (qubits implemented as electron spins in conducting carbon nanospheres) (Náfrádi et al., “Room temperature manipulation of long lifetime spins in metallic-like carbon nanospheres,” arXiv:cond-mat/1611.07690, 2016).

### Classical Computer

In some cases, the systems, media, networks, and methods described herein comprise a classical computer (e.g., a digital computer), or use of the same. In some cases, a classical computer may comprise a digital computer. In some cases, the classical computer includes one or more hardware central processing units (CPUs) that carry out the classical computer's functions. In some cases, the classical computer further comprises an operating system (OS) configured to perform executable instructions. In some cases, the classical computer is connected to a computer network. In some cases, the classical computer is connected to the Internet such that it accesses the World Wide Web. In some cases, the classical computer is connected to a cloud computing infrastructure. In some cases, the classical computer is connected to an intranet. In some cases, the classical computer is connected to a data storage device.

In some cases, the classical computer is connected to a computer network. In some cases, the classical computer is connected to the Internet such that it accesses the World Wide Web. In some cases, the classical computer is connected to one or more computer servers, which can enable distributed computing, such as a cloud computing infrastructure. In some cases, the classical computer is connected to an intranet and/or extranet or an intranet and/or extranet that is in communication with the Internet. In some cases, the classical computer is connected to a data storage device. In some cases, the network is a telecommunication and/or data network. In some cases, the network is a peer-to-peer network, which may enable devices coupled to the computer system to behave as a client or a server.

In accordance with the description herein, suitable classical computers may include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Smartphones may be suitable for use with methods and systems described herein. Select televisions, video players, and digital music players, in some cases, with computer network connectivity, may be suitable for use in the systems and methods described herein. Suitable tablet computers may include those with booklet, slate, and convertible configurations.

In some cases, the classical computer includes an operating system configured to perform executable instructions. The operating system may be, for example, software, including programs and data, which manages the device's hardware and provides services for execution of applications. Suitable server operating systems include, by way of non-limiting examples, FreeBSD, OpenBSD, NetBSD®, Linux®, Apple® Mac OS X Server®, Oracle® Solaris®, Windows Server®, and Novell® NetWareR. Suitable personal computer operating systems may include, by way of non-limiting examples, Microsoft® Windows®, Apple® Mac OS X®, Apple® macOS®, UNIX®, and UNIX-like operating systems such as GNU/Linux®. In some cases, the operating system is provided by cloud computing. Suitable mobile smart phone operating systems may include, by way of non-limiting examples, Nokia® Symbian® OS, Apple® iOS®, Research In Motion® BlackBerry OS®, Google® Android®, Microsoft® Windows PhoneR OS, Microsoft® Windows Mobile® OS, Linux®, and Palm® WebOS®. Suitable media streaming device operating systems may include, by way of non-limiting examples, Apple TV®, Roku®, Boxee®, Google TV®, Google Chromecast®, Amazon Fire®, and Samsung® HomeSync®. Suitable video game console operating systems may include, by way of non-limiting examples, Sony® PS3®, Sony® PS4®, Microsoft® Xbox 360®, Microsoft® Xbox One®, Nintendo® Wii®, Nintendo® Wii U®, and Ouya®.

In some cases, the classical computer includes a storage and/or memory device. In some cases, the storage and/or memory device is one or more physical apparatuses used to store data or programs on a temporary or permanent basis. In some cases, the storage and/or memory device may have one or more additional data storage units that are external to the classical computer, for example, being located on a remote server that is in communication with the classical computer through an intranet or the Internet. In some cases, the device is volatile memory and requires power to maintain stored information. In some cases, the device is non-volatile memory and retains stored information when the classical computer is not powered. In some cases, the non-volatile memory comprises flash memory. In some cases, the non-volatile memory comprises dynamic random-access memory (DRAM). In some cases, the non-volatile memory comprises ferroelectric random access memory (FRAM). In some cases, the non-volatile memory comprises phase-change random access memory (PRAM). In some cases, the device is a storage device including, by way of non-limiting examples, CD-ROMs, DVDs, flash memory devices, magnetic disk drives, magnetic tapes drives, optical disk drives, and cloud computing based storage. In some cases, the storage and/or memory device is a combination of devices such as those disclosed herein.

In some cases, the classical computer includes a display to send visual information to a user. In some cases, the display is a cathode ray tube (CRT). In some cases, the display is a liquid crystal display (LCD). In some cases, the display is a thin film transistor liquid crystal display (TFT-LCD). In some cases, the display is an organic light emitting diode (OLED) display. In some cases, on OLED display is a passive-matrix OLED (PMOLED) or active-matrix OLED (AMOLED) display. In some cases, the display is a plasma display. In some cases, the display is a video projector. In some cases, the display is a combination of devices such as those disclosed herein.

In some cases, the classical computer includes an input device to receive information from a user. In some cases, the input device is a keyboard. In some cases, the input device is a pointing device including, by way of non-limiting examples, a mouse, trackball, track pad, joystick, game controller, or stylus. In some cases, the input device is a touch screen or a multi-touch screen. In some cases, the input device is a microphone to capture voice or other sound input. In some cases, the input device is a video camera or other sensor to capture motion or visual input. In some cases, the input device is a Kinect, Leap Motion, or the like. In some cases, the input device is a combination of devices such as those disclosed herein.

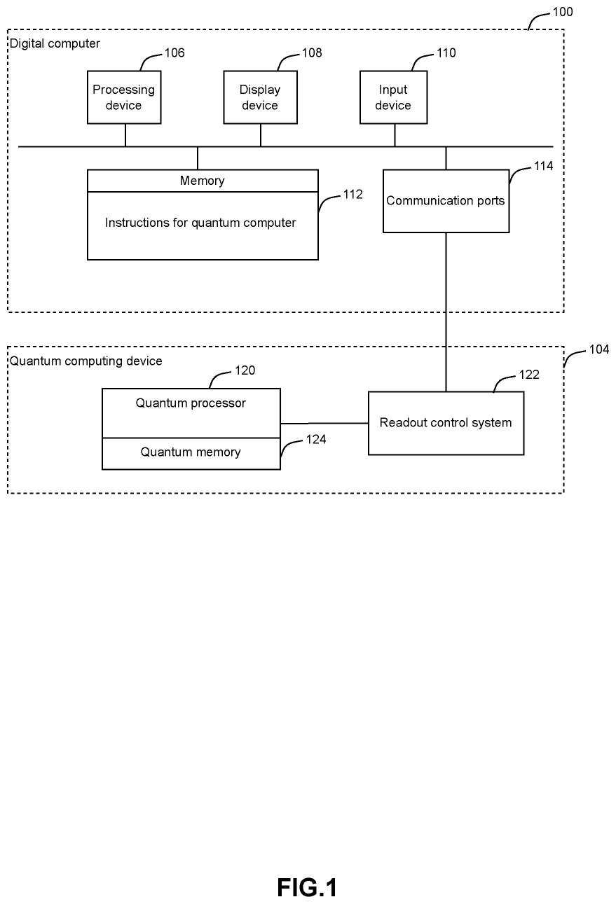

Now referring to FIG. 1, there is shown a diagram of a system for eigenstate preparation of a target Hamiltonian on a quantum computer. The system comprises digital computer 100 and non-classical computer (e.g., a quantum computer, a quantum computing device, etc.) 104. Digital computer 100 comprises at least one processing device 106, a display device 108, an input device 110, communications ports 114 and memory 112 comprising a computer program executable by processing device 106. Digital computer 100 may be of various types, such as any digital computer disclosed herein.

Still referring to FIG. 1, quantum computer 104 comprises quantum processor 120 having quantum memory 124. In some cases, quantum computer 104 comprises readout control system 122 for quantum measurement readouts. Quantum computer 104 is operatively connected to digital computer 100 by way of the connection between readout control system 122 and communications ports 114. Quantum computer 104 may comprise any quantum computer such as any quantum device disclosed elsewhere herein.

In some cases, digital computer 100 is used for providing instructions to quantum computer 104 using communications ports 114 and readout control system 122.

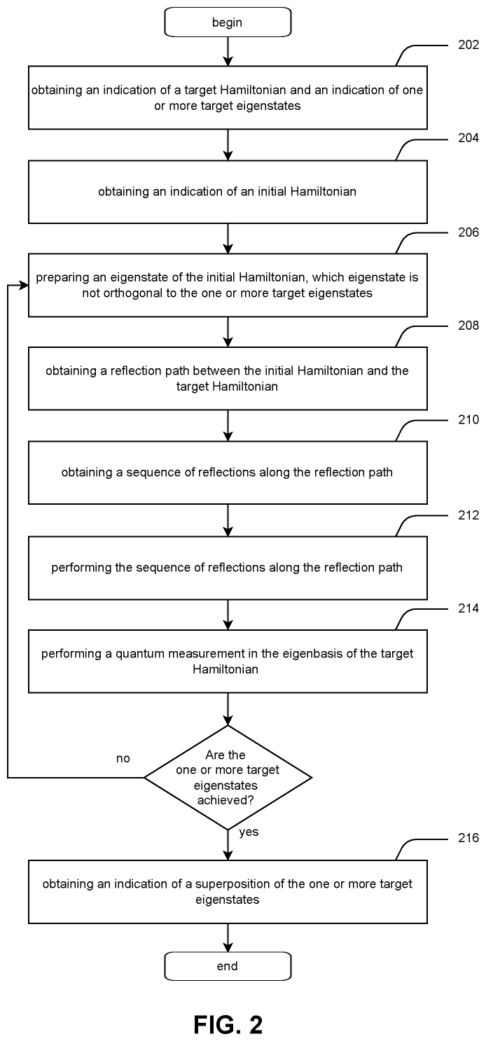

Now referring to FIG. 2, there is shown a flowchart of a method for eigenstate preparation of a target Hamiltonian on a quantum computer.

According to processing operation 202, an indication of a target Hamiltonian and an indication of one or more target eigenstates are obtained. The indication of the target Hamiltonian may be of various types. In some cases, the indication of the target Hamiltonian is a mathematical operator representing the energy observable.

The one or more target eigenstates may be of various types. In some cases, the indication of the one or more target eigenstates is represented via energy intervals. In some cases, the indication of the one or more target eigenstates is an integer number representative of one or more eigenstates having the lowest energies. In some cases, the indication of the one or more target eigenstates is an integer number representative of one or more eigenstates having the highest energies. In some cases, the indication of the one or more target eigenstates is represented using labels.

In an example, a target Hamiltonian may be a k-body Ising Hamiltonian ΣₗJₗ Π_{i∈Ω}_{ₗ} zᵢ (where zᵢ is the Pauli

$$z = ( \begin{matrix}1 & 0 \\ 0 & - 1\end{matrix} )$$

operator acting on the qubit i and Jₗ is the coupling term for the ensemble Ωₗ involved in a given term of at maximum k spins), and the target state(s) could be the ground state(s) of the target Hamiltonian.

In some cases, the target Hamiltonian may be representative of an optimization problem with constraints. In some cases, the target Hamiltonian is representative of satisfiability problem. For example, a satisfiability problem may be a satisfiability in conjunctive normal form (CNF). A type of CNF SAT problem may be a kSAT problem. A kSAT problem may have a number, k, of literals. A SAT problem may be structured such that a number of literals between 1 and k must be true. For example, a kSAT problem may be a 3SAT problem. In some cases, the number k may be about 2, about 3, about 4, about 5, about 6, about 7, about 8, about 9, about 10, about 30, about 50, or more. In an example, the target Hamiltonian may be representative of a MAX-SAT problem. A SAT problem may be an unrestricted SAT problem, a one-in-three 3SAT problem, a linear SAT problem, a HORNSAT, an XOR-SAT, etc. A MAX-SAT problem may be a generalization of a kSAT problem. A MAX-SAT problem may concern maximizing the number of constraints that must be satisfied by a set of variables.

In some cases, the target Hamiltonian may be representative of an optimization problem. Examples of optimization problems comprise a kSAT problem, a spin-glass problem, and a quadratic unconstrained binary optimization problem. In some cases, the target Hamiltonian may be representative of a quantum many-body system. In some cases, the target Hamiltonian may be representative of a fermionic system. In some cases, the target Hamiltonian may be representative of a bosonic system.

The indication of the target Hamiltonian and the indication of the one or more target eigenstates may be obtained in various ways. In some cases, the indication of the target Hamiltonian and the indication of the one or more target eigenstates may be obtained using a digital computer such as any digital computer 100 disclosed herein with respect to FIG. 1. In some cases, the indication of the target Hamiltonian and the indication of the one or more target eigenstates may be stored in the memory 112 of the digital computer 100. In some cases, the indication of the target Hamiltonian and the indication of the one or more target eigenstates may be obtained from a remote processing unit operatively coupled with the digital computer 100.

In an example, a kSAT problem may be solved by finding the ground state energy of a corresponding k-body Ising Hamiltonian. For example, in a 3SAT problem, for every clause vᵢ∨vⱼ∨vₗ (where vᵢ is a Boolean variable, also called a positive literal), the terms zᵢ+zⱼ+zₗ+zᵢzⱼ+zᵢzₗ+zⱼzₗ+zᵢzⱼzₗ are added. If an odd number of literals is negative, the corresponding terms are subtracted. For example, vᵢ∨¬vⱼ∨¬vₗ (where ¬vⱼ is a negative literal, e.g., the negation of the variable vⱼ) leads to the terms zᵢ−zⱼ−zₗ−zᵢzⱼ−zᵢzₗ+zⱼzₗ+zᵢzⱼzₗ. Each satisfied clause corresponds to an energy diminution of 1. Thus, a ground state energy equal to the negative of the number of clauses would correspond to a satisfiable instance, and for an energy greater than that, it would be unsatisfiable.

Still referring to FIG. 2 and according to processing operation 204, an indication of an initial Hamiltonian is obtained. The indication of the initial Hamiltonian may be obtained in various ways. In some cases, the indication of the initial Hamiltonian may be obtained using a digital computer such as any digital computer 100 disclosed herein with respect to FIG. 1. In some cases, the indication of the initial Hamiltonian may be stored in the memory 112 of the digital computer 100. In some cases, the indication of the initial Hamiltonian may be obtained from a remote processing unit operatively coupled with the digital computer 100.

The indication of the initial Hamiltonian may be of various types. In some cases, the indication of the initial Hamiltonian is a self-adjoint operator representing the energy observable.

In some cases, for a classical target Hamiltonian that is diagonal in the computational basis, a transverse-field Hamiltonian—Σᵢxᵢ, where xᵢ is the Pauli

$$x = ( \begin{matrix}0 & 1 \\ 1 & 0\end{matrix} )$$

operator acting on the qubit i, may be used. The ground state of the transverse-field Hamiltonian may be an equal superposition of all states of the computation basis |+ [symbol] ^{⊗n} for a system of size n, and thus, it may guarantee a non-zero overlap with all eigenstates of the target Hamiltonian.

Still referring to FIG. 2 and according to processing operation 206, an eigenstate of the initial Hamiltonian is prepared on a quantum computer. In some cases, the prepared eigenstate of the initial Hamiltonian is not orthogonal to the one or more target eigenstates. The eigenstate of the initial Hamiltonian may be such that it is straightforward to prepare on the quantum computer. The quantum computer may be of various types such as any quantum computer 104 disclosed herein with respect to FIG. 1.

In some cases, a Hadamard gate,

$$H = \frac{1}{\sqrt{2}} ( \begin{matrix}1 & 1 \\ 1 & - 1\end{matrix} )$$

may be applied to each qubit to prepare the ground state of the transverse-field Hamiltonian from qubits that are in a zero state, |0 [symbol] ^{⊗n}.

In some cases, an eigenstate of the initial Hamiltonian is prepared using a unitary decomposition. The initial Hamiltonian may be constructed from a unitary decomposition. An example of a unitary decomposition procedure may be found in Krol, A. M., et al, “Efficient decomposition of unitary matrices in quantum circuit compilers,” arXiv:2101.02993 (2021), which is incorporated by reference herein for all purposes. If a state |ψ [symbol] has a non-zero overlap with the target state, the initial Hamiltonian may be defined as [symbol] −2|ψ [symbol] [symbol] ψ|, where ∥ is an identity operator Unitary decomposition may be used both for the initial Hamiltonian's construction and to prepare the initial state |ψ [symbol] with a unitary of the form |ψ [symbol] [symbol] 00 . . . 0|+|ψ′ [symbol] 00 . . . 0 [symbol] ^{⊥}|, where the second term is required to ensure the unitarity of the operation and wherein [symbol] 00 . . . 0^{⊥}|00 . . . 0 [symbol] =0.

In some cases, an eigenstate of the initial Hamiltonian is the ground state of the initial Hamiltonian. In some cases, the ground state may define a region representative of constraints of an optimization problem. For example, in a MAX2SAT problem, such a constraint may be that the two specific variables, v₁ and v₂, cannot both be true. Instead of starting from an equal superposition of all states (such as the ground state of the transverse-field Hamiltonian), the states of the initial superposition wherein v₁=v₂=1 may be excluded. Then an initial Hamiltonian whose ground state is defined by the constraint may be constructed.

According to processing operation 208, a reflection path between the initial Hamiltonian and

the target Hamiltonian is obtained. The reflection path may be obtained in various ways. In some cases, the reflection path may be obtained using a digital computer such as any digital computer 100 disclosed herein with respect to FIG. 1. In some cases, the reflection path may be stored in the memory 112 of the digital computer 100. In some cases, the reflection path may be obtained from a remote processing unit operatively coupled with the digital computer 100.

In some cases, the reflection path is obtained from a user. In some cases, the reflection path is obtained using an adiabatic path. In some cases, the reflection path is obtained using prior information.

A reflection may be a quantum gate operation that changes the phase of a subset of states of a given orthonormal basis. In some cases, each reflection is performed using gate operations such as phase kickback. A reflection may be performed by replacing a projective measurement by a (multi) controlled-NOT (CNOT) gate where the controlled qubits are one or more data qubits and the target qubit is an ancilla qubit in the minus state |− [symbol] =(|0 [symbol] −|1 [symbol] )/√2. Performing an X measurement may lead to an outcome corresponding to the −1 eigenvalue. The minus phase may be transferred to the corresponding state in the superposition resulting in a desired reflection. In some cases, the reflection may be performed using quantum phase estimation without performing an energy measurement and by performing an energy comparison with the energy threshold. For instance, if the sequence of reflections is a discretization of an adiabatic path, performing a phase estimation (without measurements) of the exponential of the Hamiltonian may store the energy value in a quantum register. A negative phase may be added to states with an arithmetic operation when the energy is above, below, or in between energy thresholds which may result in a desired reflection. In some cases, the reflections R may be performed by using a binary function g: {0,1}^{⊗n}→{0,1} defined on the set of labels, y∈{0,1}^{⊗n} of the eigenstates |y [symbol] , such that the binary function marks the states around which the reflection is performed: R|y [symbol] =(−1)^{g(y)}|y [symbol] . In some cases, the reflections may be performed using qubitization. Thus, each reflection is performed around the eigenstate(s) of the qubitized Hamiltonian instead of the Hamiltonian itself. In some cases, the function marking the eigenstates is calculated using quantum signal processing.

A reflection path may be a continuous function defined from a bounded interval of real numbers to a Hilbert space which contains both initial and target Hamiltonians. For example, a may be defined to be the lower bound of the interval and b the upper bound of the interval. Then, the reflection path is a continuous function ƒ(x), such that ƒ(a) equals the initial Hamiltonian and ƒ(b) equals the target Hamiltonian. The reflection path may be used to define the sequences of reflections of the algorithm.

For example, a reflection path for solving a kSAT problem may be a linear interpolation between a transverse-field Hamiltonian and the corresponding k-body Ising Hamiltonian, e.g., −(1−w)Σᵢxᵢ+w ΣₗJₗ Π_{(i∈Q}_{ₗ}₎zᵢ for w between 0 and 1.

Still referring to FIG. 2 and according to processing operation 210, a sequence of reflections along the reflection path may be obtained. The sequence of reflections may be obtained in various ways. In some cases, the sequence of reflections may be obtained using a digital computer such as any digital computer 100 disclosed herein with respect to FIG. 1. In some cases, the sequence of reflections may be stored in the memory 112 of the digital computer 100. In some cases, the sequence of reflections may be obtained from a remote processing unit operatively coupled with the digital computer 100. In some cases, the sequence of reflections may be obtained from a user. In some cases, the sequence of reflections may be obtained using an optimization protocol such as a gradient-based optimization procedure or a derivative free optimization procedure. The optimization protocol may be used either on a classical simulation of the quantum algorithm or on the results obtained from quantum computations. The protocol may optimize a cost function computed using samples of the final energy of the system. It may then update the reflection path, the discretization of the reflection path, the (eigen)states defining the reflections or the energy threshold for each reflection. In some cases, the sequence of reflections is obtained using an optimization protocol. For example, an optimization protocol may be based at least in part on a method selected from the group consisting of a gradient descent method, a stochastic gradient descent method, a steepest descent method, a Bayesian optimization method, a random search method, and a local search method. In some cases, the sequence of reflections is obtained using a machine learning method. The machine learning method could be trained for a specific class of problems, for examples to find the reflection path, the discretization of the reflection path, the (eigen)states defining the reflections or the energy threshold for each reflection. In some cases, the sequence of reflections may be obtained using prior information.

A sequence of reflections may be defined as reflections around some eigenstates of each selected Hamiltonian on the reflection path. For instance, a constant step discretization of the reflection path may be selected to solve a kSAT problem. The reflections may be performed around the ground state of each instantaneous Hamiltonian. For example, for the reflection path −(1−w)Σᵢxᵢ+w ΣₗJₗ Π_{(i∈Q}_{ₗ}₎zᵢ the instantaneous Hamiltonians corresponding to w={0.25,0.5,0.75} may define a sequence of three reflections or an initial guess of a discretization of the reflection path to be optimized by an optimization protocol.

Still referring to FIG. 2 and according to processing operation 212, the sequence of reflections along the reflection path may be performed using a quantum computer. The quantum computer may be of various types such as any quantum computer 104 disclosed herein with respect to FIG. 1.

According to processing operation 214, a quantum measurement in the eigenbasis of the target Hamiltonian may be performed. A quantum measurement may be a manipulation of a physical system (e.g., of qubits) that yields numerical results representative of the state of the qubits. The quantum measurement may be performed to check that the target eigenstates are achieved. The indication of the one or more target eigenstates obtained according to processing operation 202 may be used to check that the target eigenstates are achieved. For example, when the eigenstates correspond to the energy observable, a quantum phase estimation may be performed. It may compute the energy (in the computational basis) of each eigenstate of the target Hamiltonian using a register of ancilla qubits. Before measurement, the two registers may be entangled, wherein the second register contains energy corresponding to the eigenstate in the first register. Measuring the energy register (e.g., the second register) may provoke the state to collapse into the corresponding eigenstate(s). The energy may be obtained in the computational basis and may be used to verify that the target eigenstates are achieved. In some cases, the quantum measurement (e.g., quantum phase estimation) may be performed by implementing a unitary operator, such as e^{-iH}^{_{target}}, where H_{target} is the target Hamiltonian, to implement the energy measurement or partial energy measurement. In some cases, the unitary operator may be implemented using Trotterization or qubitization. In some cases, wherein the indication of the target eigenstates is represented using labels, a binary function g: {0,1}^{⊗n}→{0,1} that marks the target eigenstates may be used (e.g., g(y)=1 if y is one of the target eigenstates, otherwise g(y)=0). The result of the function calculation may be stored and measured using an ancilla qubit. Such a function may be computed using quantum signal processing. To check if the target eigenstates are achieved a digital computer such as any digital computer 100 disclosed herein with respect to FIG. 1 may be used. If the target eigenstates are achieved, then the method proceeds to processing operation 216. If the target eigenstates are not achieved, then the method returns to processing operation 206.

In some cases, a measurement of the energy (such as the measurement for performing the reflections or for performing processing operation 214) may be replaced by a partial energy measurement.

Still referring to FIG. 2 and according to processing operation 216, an indication of a superposition of the one or more target eigenstates is obtained. The indication of the superposition of the one or more target eigenstates may be obtained in various ways. In some cases, the indication of the superposition of the one or more target eigenstates may be obtained using a quantum computer such as any quantum computer 104 disclosed herein with respect to FIG. 1. In some cases, superposition of the one or more target eigenstates may be stored in a quantum memory such a quantum memory 124 disclosed herein with respect to FIG. 1. In some cases, superposition of the one or more target eigenstates may be obtained by a remote processing unit operatively coupled to the quantum computer 104.

In some cases, the indication of the superposition of the one or more target eigenstates comprises partial information or approximations of the superposition of the one or more target eigenstates is obtained. The partial information may be obtained in various ways. This includes, but is not limited to, any output of the process, such as energies, labels or any information obtained by sampling the superposition. In some cases, the partial information may be obtained using a digital computer such as any digital computer 100 disclosed herein with respect to FIG. 1. In some cases, the partial information may be stored in the memory 112 of the digital computer 100. In some cases, partial information may be obtained by a remote processing unit operatively coupled to the digital computer 100.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

What is claimed is:

1. A method for preparing an eigenstate of a target Hamiltonian using a quantum computer, the method comprising:
(a) obtaining a reflection path between an initial Hamiltonian and a target Hamiltonian;
(b) using one or more target eigenstates to obtain a sequence of reflections along said reflection path; and
(c) using said quantum computer to perform said sequence of reflections along said reflection path.

2. The method of claim 1, wherein, subsequent to (c), the method comprises, at said quantum computer, performing a measurement in the eigenbasis of said target Hamiltonian, and, wherein said measurement in said eigenbasis of said target Hamiltonian is performed to check that said one or more target eigenstates are achieved.

3. The method of claim 2, wherein the method further comprises obtaining an indication of a superposition of said one or more target eigenstates.

4. The method of claim 1, wherein an indication of said one or more target eigenstates comprises at least one of: energy intervals, an integer number representative of a number of eigenstates having the lowest energies, an integer number representative of a number of eigenstates having the highest energies, labels, and a binary function that marks the target eigenstates.

5. The method of claim 1, wherein (c) comprises, at said quantum computer, performing said sequence of reflections using a plurality of gate operations.

6. The method of claim 5, wherein said plurality of gate operations comprises phase kickback or energy comparison.

7. The method of claim 1, wherein (c) comprises, at said quantum computer, performing a quantum phase estimation without performing an energy measurement.

8. The method of claim 7, wherein (c) comprises performing at least one of qubitization, quantum signal processing, and partial energy measurement.

9. The method of claim 2, wherein said measurement comprises a quantum measurement comprising at least one of: qubitization, quantum signal processing, or partial energy measurement.

10. The method of claim 1, wherein said quantum computer comprises at least one member of the group consisting of: a circuit-based quantum computer, a superconducting quantum computer, a trapped ion quantum computer, a quantum dot computer, an optical quantum computers, a nuclear magnetic resonance (NMR) quantum computer, a solid-state NMR Kane quantum computer, an electrons-on-helium quantum computer, a cavity quantum electrodynamics-based quantum computer, a molecular magnet-based quantum computer, a fullerene-based ESR quantum computer, a diamond-based quantum computer, a Bose-Einstein condensate-based quantum computer, a transistor-based quantum computer; a rare-earth-metal-ion-doped inorganic crystal-based quantum computer, and a metal-like carbon nanospheres based quantum computer.

11. The method of claim 1, wherein (a)-(c) are repeated at least once.

12. The method of claim 2, wherein (a)-(c) and said performing said measurement in the eigenbasis of said target Hamiltonian are repeated at least once.

13. The method of claim 3, wherein (a)-(c) and said obtaining of an indication of superposition of said one or more target eigenstates are repeated at least once.

14. The method of claim 1, wherein (b) comprises using an optimization protocol to obtain said sequence of reflections, wherein said optimization protocol is based at least in part on one or more methods selected from the group consisting of: a gradient-based optimization procedure, a derivative free optimization procedure, a gradient descent, a stochastic gradient descent, a steepest descent, a Bayesian optimization, a random search, and a local search.

15. The method of claim 1, wherein (b) comprises using machine learning method to obtain said sequence of reflections.

16. The method of claim 1, wherein (a) or (b) or both comprise using prior information to obtain said sequence of reflections, said reflection path, or both.

17. The method of claim 1, wherein (a) comprises using an adiabatic path to obtain said reflection path.

18. The method of claim 1, wherein said target Hamiltonian is representative of at least one member of the group consisting of: an optimization problem, a kSAT problem, a spin-glass problem, a quadratic unconstrained binary optimization problem, an optimization problem with at least one constraint, a quantum many-body system, a fermionic system, and a bosonic system.

19. The method of claim 18, wherein said eigenstate of said initial Hamiltonian is a ground state of said initial Hamiltonian, and wherein said ground state defines a region representative of said at least one constraint of said optimization problem.

20. The method of claim 1, wherein an indication of said initial Hamiltonian comprises a domain of an optimization problem.

21. A system for eigenstate preparation of a target Hamiltonian on a quantum computer, the system comprising:
a communications interface for providing instructions to said quantum computer, and for obtaining quantum measurements results; and
a digital computer comprising an interface and a non-transitory computer readable medium operatively coupled to a processor, said non-transitory computer readable medium comprising instructions, wherein said processor is configured to execute said instructions to at least:
(a) obtain a reflection path between an initial Hamiltonian and a target Hamiltonian;
(b) use one or more eigenstates to obtain a sequence of reflections along said reflection path; and
(c) provide instructions, using said communications interface, to said quantum computer to perform a sequence of reflections along said reflection path.
